(19) United States
(12) Patent Application Publication
(10) Pub. No.: US 2011/0188262 A1
(43) Pub. Date: Aug. 4, 2011

(54) LIGHT CONDUCTIVE PLATE AND MANUFACTURING METHOD THEREOF

(75) Inventors: Masahiro ISAGO, Kitasaku-gun (JP); Takumi SAITO, Kitasaku-gun (JP); Hiroshi CHOU, Kitasaku-gun (JP)

(73) Assignee: MINEBEA CO., LTD., KITASAKU-GUN (JP)

(21) Appl. No.: 13/011,472

(22) Filed: Jan. 21, 2011

(30) Foreign Application Priority Data
Feb. 1, 2010 (JP) 2010-020635

(51) Int. Cl. G02B 6/00; B29C 59/02

(52) U.S. Cl. 362/582; 264/293

(57) ABSTRACT

There is provided a light conductive plate comprising: a resin sheet; and a plurality of concave dots formed on a surface of the resin sheet, wherein each concave dot in section includes a general formed portion in which to be continuously formed from an opening end portion of the concave dot toward a deep portion thereof, and a discontinuous formed portion that is fabricated at the deepest portion of the general formed portion.

### BACKGROUND OF THE INVENTION

1. Field of the Invention

The present invention relates to a light conductive plate and a manufacturing method thereof that apply for illumination of the display portion, the operation portion, etc. of an electronic device, and the like.

2. Description of the Related Art

In the past a backlight illumination has been applied for the display portion or the operation portion of electronic devices, and in recent years it has become more general to apply the same backlight illumination to portable electronic devices such as a notebook type personal computer, a cellular phone, and the like. For the backlight illumination, a spread illumination apparatus has been widely applied, the spread illumination apparatus including a light conductive plate where light is introduced from a light source and emits from the surface of the light conductive plate so as to diffuse the light in a wide range.

Considering FIG. 4, one example of conventional spread illumination apparatuses is depicted in an exploded perspective view. In the spread illumination apparatus, a point-like light source 1 is arranged at a place adjacent to the one-side end face (incident surface) 4 of a light conductive plate 2. The spread illumination apparatus is structured as that light emitted from the point-like light source 1 is adapted to exit out from an exit surface 3 of the light conductive plate 2 so as to be guided toward an illuminated body 8 side. The point-like light source 1 is structured, for example, as that an LED chip is covered with a case which has an exit window. Exit light is thus adapted to effectively exit out from the exit window in one direction. The point-like light source (LED) 1 is arranged as that the front side thereof faces to the one-side end face 4 of the light conductive plate 2. The light conductive plate 2 is made of highly transparent materials such as acrylic, polycarbonate, polyester, poly methyl methacrylate, etc. A back surface 5 of the light conductive plate 2, that is, a surface opposed to the exit surface 3, is provided with a later-explained light reflection pattern being able to uniformly exit light that has been introduced from the LED 1 to the interior of the light conductive plate 2 at the entire area of the exit surface 3. Further, a reflecting plate 6 is provided on the back surface 5 side of the light conductive plate 2 so as to cover the back surface 5. The reflecting plate 6 is composed of reflex materials such as white resin, silver-plated plate, etc. whereby light that has been emitted from the back surface 5 of the light conductive plate 2 to outside is reflected so as to be re-introduced into the light conductive plate 2. On the other hand, on the main surface side of the light conductive plate 2, that is, the exit surface side 3 side, an optical filter 7 such as a light diffusion sheet, a luminance enhancement film, etc. is laminated. Here, a member indicated with a reference number 9 in FIG is a reflecting sheet provided with a light diffusion portion 9a.

In the example as shown in FIG. 4, as the illuminated body 8, a liquid crystal display device provided with a display area 8a and a non-display area 8b is arranged; however, for example, in case that the spread illumination apparatus is structured for a keyboard, a keyboard switch will be arranged as the illuminated body 8. Further, the laminated structure of the front and the rear surfaces of the light conductive plate 2, or the ambient structure of the point-like light source 1 is optionally modifiable.

The light reflection pattern of the light conductive plate 2 is full of shape devisal for improving optical properties. For example, the light reflection pattern is provided with an optically transparent base member and a plurality of optically transparent striped bodies that are provided on the base member. A section orthogonal to a direction in which the striped bodies extend is composed of a triangular first sectional portion defined with a first side to a third side, and a second sectional portion including a plurality of triangular bodies, each of the triangular bodies having an area smaller than one of the first sectional portion and being defined by a fourth side to a sixth side. Further, the first side of the first sectional portion abuts to the surface of the above base member in parallel while the plurality of triangular bodies is arranged on the second side of the first sectional portion with no space. Still further, the fourth side of each of the triangular bodies abuts to the second side of the first sectional portion in parallel while a number of the triangular bodies are more than 2 pieces (inclusive) but less than 9 pieces (inclusive). See Patent Application Laid-open No. 2009-134179.

As discussed hereinabove, the light conductive plate 2 is fabricated with various materials in high transparency. In case that a transparent acrylic resin is, for example, applied, its manufacturing method may be injection molding. Or, as shown in FIGS. 5A and 5B, the following method may be applied. That is, a resin sheet 12 is heated with a die 14, and predetermined convex forms 14a on the die 14 are heat-transferred on the resin sheet 12 so as to form concave forms 16. Here, FIG. SA shows only an upper die for convenience sake; however, a lower die should be properly provided. In any cases, the conventional manufacturing methods are as that resin materials are melted, and the cavity formation of the die is accurately transferred on the light conductive plate. Accordingly, the formation of the light conductive plate tends to be undifferentiated due to the cavity formation of the die making the diffusing direction of light undifferentiated. The improvement of light diffusion has been thus demanded. Further, not only does the cost of equipment to apply heat and cooling to the die increases but also the die can not be released until molten resin is hardened to a certain extent making a cycle time per one mold difficult to shorten.

### SUMMARY OF THE INVENTION

The present invention has been made in light of the above problems, and it is an object of the present invention to provide a light conductive plate having superior optical characteristics and stable qualities. Further, the object is also to provide the optically superior light conductive plate as low cost as possible.

Embodiments according to the present invention hereinbelow exemplify some structures of the present invention, and are itemized for facilitating understanding of various structures of the present invention. Each item does not intend to limit the technical scope of the present invention. While considering the best modes to carry out the present invention, even if components of each item is partially substituted or deleted, or even if another component is added thereto, these should be regarded as the elements of the technical scope of the present invention.

In order to achieve the object described above, according to a first aspect of the present invention, there is provided a light conductive plate comprising: a resin sheet; and a plurality of concave dots formed on a surface of the resin sheet, wherein each concave dot in section includes a general formed portion in which to be continuously formed from an opening end portion of the concave dot toward a deep portion thereof, and a discontinuous formed portion that is fabricated at the deepest portion of the general formed portion.

In the light conductive plate with this configuration, since each concave dot formed on the surface of the resin sheet has the discontinuous formed portion at the deepest portion of the general formed portion, a factor to deform the formation of the concave dots is eliminated from the general formed portion contributing to form stabilization of the general formed portion. Further, in the general formed portion, it deflects light that has been introduced from a light source to the interior of the light conductive plate, being able to obtain necessary luminance.

In the first aspect of the present invention, the general formed portion is a light diffusion portion, and the discontinuous formed portion is a stress-releasing portion.

In the light conductive plate with this configuration, stress generable on the resin sheet through this manufacturing process of the light conductive plate will concentrate on the stress-releasing portion of the discontinuous formed portion that is provided at the deepest portion of the light diffusion portion of the general formed portion. Accordingly, since the stress can be released from the light diffusion portion, it would be possible to stabilize the formation of the light diffusion portion.

In a second aspect of the present invention, there is provided a light conductive plate comprising: a resin sheet; and a plurality of concave dots formed on a surface of the resin sheet, wherein each concave dot includes a light diffusion portion and a stress-releasing portion fabricated at the deepest portion of the light diffusion portion.

In the light conductive plate with this configuration, stress generable on the resin sheet through the manufacturing process of the light conductive plate will be released at the stress-releasing portion provided at the deepest portion of the light diffusion portion contributing to form stabilization of the light diffusion portion. Further, in the light diffusion portion, it deflects light that has been introduced from the light source to the interior of the light conductive plate so as to obtain necessary luminance.

In the first aspect and the second aspect of the present invention, the concave dots are formed through a cold press by means of a press die on which a plurality of convex projections is provided.

In the light conductive plate with this configuration, the plurality of convex projections formed on the press die are pressed (press-stressed) on the surface of the resin sheet through the cold process causing material flow with no melting in the resin sheet so as to form the concave dots on the surface of the resin sheet. Here, stress generated on the resin sheet by which the convex projections of the press die are pressed will concentrate on either the discontinuous formed portion or the stress-releasing portion provided at the deepest portion of the general formed portion. The stress is then released from the general formed portion contributing to form stabilization of the general formed portion. Further, in the general formed portion, it deflects light that has been introduced from a light source to the interior of the light conductive plate so as to obtain necessary luminance.

In a third aspect of the present invention, there is provide a manufacturing method of a light conductive plate in which to form a plurality of concave dots on a surface of a resin sheet through a cold press by means of a press die on which a plurality of convex projections is formed, each concave dot in section including: a general formed portion that is continuously formed from an opening end portion of the concave dot toward a deep portion thereof; and a discontinuous formed potion fabricated at the deepest portion of the general formed portion.

In this manufacturing method of the light conductive plate, the plurality of convex projections formed on the press die is pressed on the surface of the resin sheet through a cold process causing material flow with no melting in the resin sheet so as to form the concave dots on the surface of the resin sheet. Here, stress generated on the resin sheet by which the convex projections of the press die are pressed will concentrate on the discontinuous formed portion provided at the deepest portion of the general formed portion. The stress is then released from the general formed portion contributing to form stabilization of the general formed portion. Further, in the general formed portion, it deflects light that has been introduced from a light source to the interior of the light conductive plate so as to obtain necessary luminance.

In a fourth aspect of the present invention, there is provide a manufacturing method of a light conductive plate in which to form a plurality of concave dots on a surface of a resin sheet through a cold press by means of a press die on which a plurality of convex projections is formed, each concave dot including: a light diffusion portion; and a stress-releasing portion fabricated at the deepest portion of the light diffusion portion.

In this manufacturing method of the light conductive plate, the plurality of convex projections formed on the press die will be pressed on the surface of the resin sheet through a cold process causing material flow with no melting in the resin sheet so as to form the concave dots on the surface of the resin sheet. Here, stress generated on the resin sheet by which the convex projections of the press die are pressed will concentrate on the stress-releasing portion provided at the deepest portion of the light diffusion portion. The stress is then released from the light diffusion portion contributing to form stabilization of the light diffusion portion. Further, in the light diffusion portion, it deflects light that has been introduced from a light source to the interior of the light conductive plate so as to obtain necessary luminance.

### BRIEF DESCRIPTION OF THE DRAWINGS

FIGS IA and 1B are sectional views of a light conductive plate according to embodiments of the present invention, the sectional views depicting a general formed portion or a stress-releasing portion fabricated at the deepest portion of a general formed portion or a light diffusion portion of concave dots where FIG. 1A shows one example of the discontinuous formed portion or the stress-releasing portion while FIG. 1B shows another example of the discontinuous formed portion or the stress-releasing portion;

FIGS. 2A to 2C are schematic diagrams depicting examples of a convex projection of a die that is applied for the manufacture of the light conductive plate according to the embodiments of the present invention;

FIG. 3 is an explanatory view to compare the light conductive plate according to the embodiments of the present invention with a light conductive plate having none of the discontinuous formed portion or the stress-releasing portion at the deepest portion of the general formed portion of the concave dot;

FIG. 4 is an exploded perspective view depicting one example of conventional spread illumination devices; and

FIGS. 5A and 5B are explanatory views depicting a conventional light conductive plate and its manufacturing method where FIG. 5A is a sectional view in the course of manufacturing the conventional light conductive plate while FIG. 5B is a sectional view and a partial expanded view of a finished light conductive plate.

### DETAILED DESCRIPTION OF THE PREFERRED EMBODIMENTS

Preferred embodiments of the present invention will be described with reference to the accompanying drawings. Here, portions that are identical with or correspondent to conventional art will be indicated with the same references without providing detail explanations thereof.

In a light conductive plate 10 according to the embodiments of the present invention, as shown in FIG. 1A, a plurality of concave dots 18 are formed on the surface of a resin sheet 12. The concave dots 18 are, for example, regularly arranged in longitudinal and horizontal manners in the plane view of the light conductive plate 10. The section of each concave dot 18 includes a general formed portion 20 continuously formed from the opening end portion toward the deep portion of the concave dot 18, and a discontinuous formed portion 22 fabricated at the deepest portion of the general formed portion 20. Here, the general formed portion 20 has a section of, for example, an equilateral triangle or a trapezoid. The discontinuous formed portion 22 may be applied with various forms as long as it is discontinuous relative to the general formed portion 20. For example, the discontinuous formed portion 22 may be a quadrangular section 22A as shown in FIG. 1A, or a polygonal section 2213 with a sharp end, a triangular section 22C, a polygonal section 22D with a rounded end, or a trapezoidal section 22E as shown in FIG. 1B.

Here, as one example, when the concave dot 18 in a conical formation has a diameter at its peripheral end portion of 0.4 mm to 0.5 mm, and has the depth of the general formed portion 20 of 130 μm to 150 μm, the discontinuous formed portion 22 is formed to have the diameter X of 5 μm to 30 μm, and the depth Y of 5 μm to 50 μm.

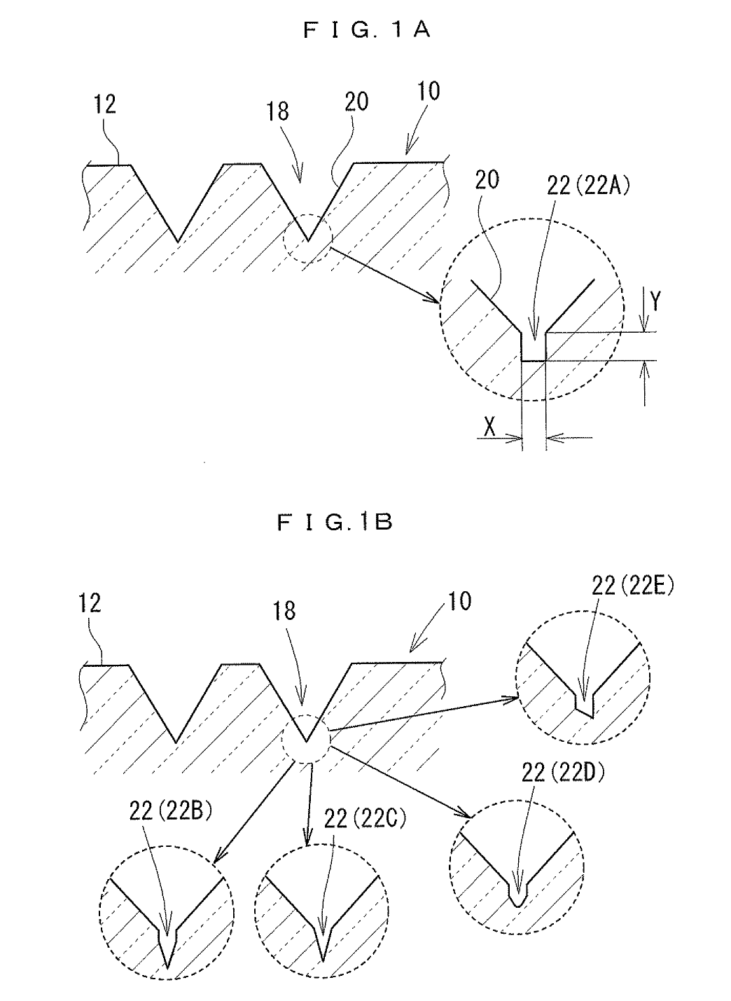

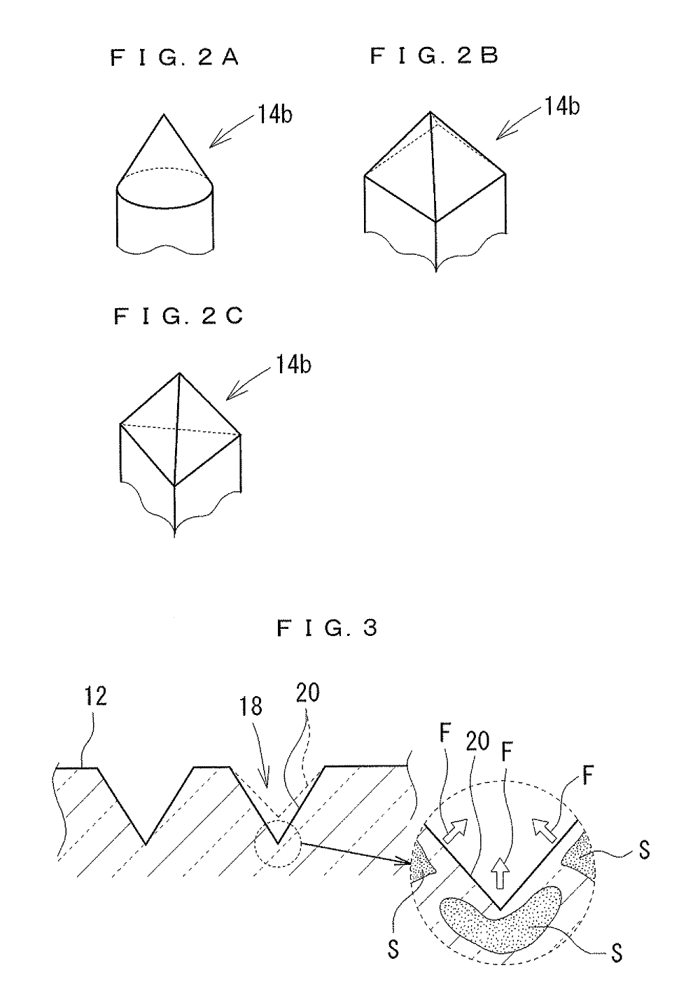

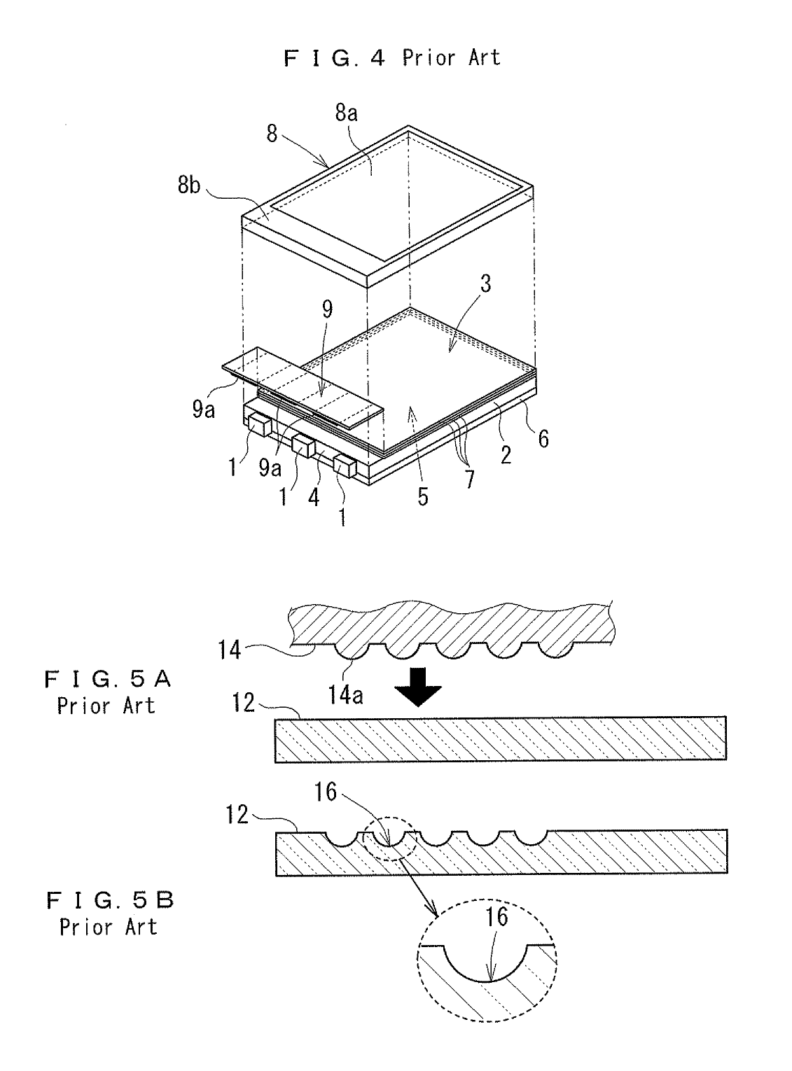

In the manufacturing method of the light conductive plate 10, the concave dots 18 are formed on the surface of the resin sheet 12 through a cold press by means of a press die 14 (see FIG. 5A) on which a plurality of convex projections are formed. Convex projections 14b of the press die 14 are, as shown in FIG. 2, applied with various formations. For example, a conical shape as shown in FIG. 2A, a quadrangular cone shape as shown in FIG. 213, or a triangular cone shape as shown in FIG. 2C may be applied.

In case that acrylic is applied as the material of the resin sheet 12, the temperature of the die is set to approximately 130° C., a clamping time is set to approximately 1 second, and a molding cycle time is set to approximately 2 seconds. Here, the melting temperature of acrylic is 80° C. to 90° C., and the temperature of the die becomes more than the melting temperature of acrylic. However, the time where the plurality of convex projections 14b formed on the die deform the resin sheet 12 is set to be a short period as discussed above whereby there can be found no melting in the resin sheet 12 (in a cold press condition).

According to the embodiments of the present invention with the above structure, the following operational effects can be obtainable. That is, in the light conductive plate 10 according to the embodiments of the present invention, since the concave dot 18 formed on the surface of the resin sheet 12 has the discontinuous formed portion 22 at the deepest portion of the general formed portion 20, it would be possible that factors to deform the formation of the concave dots (such as internal stresses) can be eliminated from the general formed portion 20 so as to be able to stabilize the formation of the general formation portion 20. Further, in the general formed portion 20, light that has been introduced from a light source to the interior of the light conductive plate 10 can be deflected and diffused so as to be able to obtain necessary luminance. Accordingly, the general formed portion 20 may be regarded as a “light diffusion portion” in view of its function. Here, since it is not especially expected for the discontinuous formed portion 22 to have effects of light deflections or light diffusions, it would be not necessary to consider the formation of the discontinuous formed portion 22 in view of luminance.

In the manufacturing method of the light conductive plate according to the embodiments of the present invention, the plurality of convex projections 14b (see FIG. 2) formed on the press die 14 (see FIG. 5) are pressed on the surface of the resin sheet 12 through a cold process so as to cause material flow with no melting in the resin sheet 12. The concave dots 18 are then formed on the surface of the resin sheet 12. Here, since the convex projections 14b of the press die 14 are pressed onto the resin sheet 12, stress will be generated on the resin sheet 12. However, the stress will be concentrated at the discontinuous formed portion 22 that is fabricated at the deepest portion of the general formed portion 20 so as to release the stress from the general formed portion 20 contributing to stabilization of the formation of the general formed portion 20. The discontinuous formed portion 22 is thus regarded as a “stress-releasing portion” in view of its function.

Here, in consideration of the manufacturing method of the present invention, supposing a case that the discontinuous formed portion 22 is not fabricated at the deepest portion of the general formed portion 20 of the concave dot 18, as shown in FIG. 3, internal stresses S will be generated through a cold press at portions adjacent to the concave dot 18 composed of only the general formed portion 20. Accordingly, due to the internal stresses S, a return deformation will be generated in a direction as shown with a reference F. The general formed portion 20 may be subjected to unnecessary deformation as shown with dotted lines so as to unstabilize the formation of each concave dot 18 whereby it would be difficult to stabilize luminous properties of the light conductive plate 10. Here, in the embodiments of the present invention, due to the discontinuous formed portion (the stress releasing portion) 22, the inner stresses S are released thereby being able to avoid the unnecessary deformation of each concave dot 18 as discussed hereinabove.

Here, the formation of the plurality of convex projections 14b (see FIG. 3) of the press die 14 (see FIG. 5) is not adapted to transfer as it is to the discontinuous formed portion 22 of the concave dot 18. To be more specific, the press die 14 is fabricated in such a manner to make top end of the convex projections 14b to be left in a feasible range by means of general processing equipments. The discontinuous formed portions 22 of the concave dot 18 are formed resulting from a cold press with the press die 14. Accordingly, each formation of the discontinuous formed portions 22 exemplified in FIG. 1 may not be intentionally formed, but each formation of every concave dot 18 may be different from each other. Here, since the discontinuous formed portion 22 is not, as discussed hereinabove, especially expected to have light deflection effects or light diffusion effects, variability of the formation of the discontinuous formed portion 22 will not give any influence to luminous properties of the light conductive plate 10.

Thus, in the manufacturing method of the light conductive plate according to the embodiments of the present invention, the plurality of concave dots are formed on the surface of the resin sheet through a cold press by means of the press die provided with the plurality of convex projections where the convex projections are formed so as to make its top end thereof to be left. Each concave dot in section includes: the general formed portion that is continuously formed from the opening end portion of the concave dot toward the deep portion thereof; and the discontinuous formed portion that is fabricated at the deepest portion of the general formed portion.

Further, in the manufacturing method of the light conductive plate according to the embodiments of the present invention, the plurality of concave dots are formed on the surface of the resin sheet through a cold press by means of the press die provided with the plurality of convex projections where the convex projections are formed so as to make its top end thereof to be left. Each concave dot includes the light diffusion portion and the stress-releasing portion that is fabricated at the deepest portion of the light diffusion portion.

Hereinbelow is only for information purpose. When a concave formation is thermal-transferred to an acrylic resin sheet so as to fabricate a light conductive plate, a molding cycle time per 1 shot has been conventionally 60 seconds. In comparison thereto, in the embodiments of the present invention, by applying the cold press, it became possible to shorten the molding cycle time up to approximately 2 seconds as discussed hereinabove. Further, in case of thermal-transferring the concave formation to the acrylic resin sheet for fabricating the light conductive plate, the temperature of a die is conventionally heated up to approximately 170° C. for completely melting the resin sheet. However, in the embodiments of the present invention, since the cold press is applied, as discussed hereinabove, the temperature of the die can be reduced to approximately 130° C. as discussed hereinabove. Any facilities for rapidly cooling down the temperature of the die will be not necessary.

1. A light conductive plate comprising: a resin sheet; and a plurality of concave dots formed on a surface of the resin sheet, wherein each concave dot in section includes a general formed portion in which to be continuously formed from an opening end portion of the concave dot toward a deep portion thereof, and a discontinuous formed portion that is fabricated at the deepest portion of the general formed portion.

2. The light conductive plate according to claim 1, wherein the general formed portion is a light diffusion portion, and the discontinuous formed portion is a stress-releasing portion.

3. A light conductive plate comprising: a resin sheet; and a plurality of concave dots formed on a surface of the resin sheet, wherein each concave dot includes a light diffusion portion and a stress-releasing portion fabricated at the deepest portion of the light diffusion portion.

4. The light conductive plate according to claim 1, wherein the concave dots are formed through a cold press by means of a press die on which a plurality of convex projections is provided.

5. A manufacturing method of a light conductive plate in which to form a plurality of concave dots on a surface of a resin sheet through a cold press by means of a press die on which a plurality of convex projections is formed, each concave dot in section including: a general formed portion that is continuously formed from an opening end portion of the concave dot toward a deep portion thereof; and a discontinuous formed potion fabricated at the deepest portion of the general formed portion.

6. A manufacturing method of a light conductive plate in which to form a plurality of concave dots on a surface of a resin sheet through a cold press by means of a press die on which a plurality of convex projections is formed, each concave dot including: a light diffusion portion; and a stress-releasing portion fabricated at the deepest portion of the light diffusion portion.

7. The light conductive plate according to claim 2, wherein the concave dots are formed through a cold press by means of a press die on which a plurality of convex projections is provided.

8. The light conductive plate according to claim 3, wherein the concave dots are formed through a cold press by means of a press die on which a plurality of convex projections is provided.
